(19) United States
(12) Patent Application Publication
(10) Pub. No.: US 2013/0335447 A1
(43) Pub. Date: Dec. 19, 2013

(54) ELECTRONIC DEVICE AND METHOD FOR PLAYING REAL-TIME IMAGES IN A VIRTUAL REALITY

(71) Applicant: HON HAI PRECISION INDUSTRY CO., LTD., New Taipei (TW)

(72) Inventors: PO-HUI LU, New Taipei (TW); CHUN-NAN YU, New Taipei (TW); CHIEH-HANG SHIH, New Taipei (TW)

(73) Assignee: HON HAI PRECISION INDUSTRY CO., LTD., New Taipei (TW)

(21) Appl. No.: 13/714,565

(22) Filed: Dec. 14, 2012

(30) Foreign Application Priority Data
Jun. 15, 2012 (TW) 101121625

(51) Int. Cl. G06T 19/00

(52) U.S. Cl. CPC G06T 19/006
USPC 345/633

(57) ABSTRACT

In a method for playing real-images in a virtual reality using an electronic device, the method generates a request for obtaining a real-time image of a scene and notifies a Virtual Reality(VR) client to send the request to a web sever to obtain the real-time image. The real-time image is cut into a sequence of static pictures by the web server, and is sent to the VR client through a network. The method triggers the VR client to play each of the sequence of static pictures to present the real-time image on a display screen of the electronic device.

### BACKGROUND

1. Technical Field

Embodiments of the present disclosure relate to electronic devices and methods for playing images, and more particularly to an electronic device and a method for playing real-time images in a virtual reality.

2. Description of related art

When a real-time image is played in a virtual reality, a media player that plays the real-time image must support a format of the real-time image. In this process, the real-time image is usually converted into an image format that is supported by the media player. Such conversion requires the media player to have more hardware.

### BRIEF DESCRIPTION OF THE DRAWINGS

FIG. 1 is a block diagram of one embodiment of an electronic device including an image playing system.

FIG. 2 is a block diagram of one embodiment of function modules of the image playing system in FIG. 1.

FIG. 3 is a flowchart of one embodiment of a method for playing real-time images in a virtual reality.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

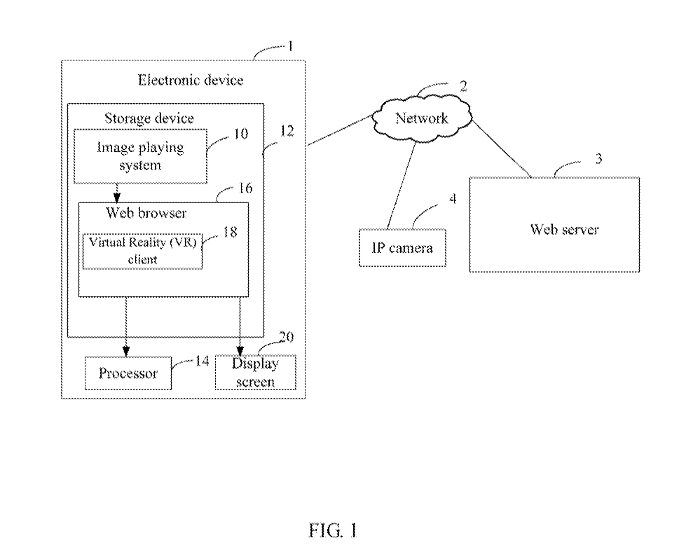

FIG. 1 is a block diagram of one embodiment of an electronic device 1 including an image playing system 10. In the embodiment, the electronic device 1 communicates with a web server 3 and an IP camera 4 through a network 2. The network 2 may be a wired or wireless network.

The electronic device 1 includes a storage device 12, at least one processor 14, and a display screen 20. The electronic device 1 may be a smart phone, a personal digital assistant, a graphics tablet, or a tablet personal computer.

The web server 3 is either hardware (e.g., a computer), software (e.g., a computer application), or a combination of both hardware and software that helps to deliver web content that can be accessed through the Internet. In the embodiment, the web server 3 obtains a real-time image from the IP camera 4, and divides the real-time image into a sequence of static pictures.

The IP camera 4 captures one or more real-time images of a scene, and changes a format of each of the real-time images into a Motion Joint Photographic Experts Group (MJPEG) format. The scene may be a supper market, a road intersection, or any other place to be monitored.

The storage device 12 may include any type(s) of non-transitory computer-readable storage medium, such as a hard disk drive, a compact disc, a digital video disc, or a tape drive. In the embodiment, the storage device 12 stores computerized codes of the image playing system 10 and a web browser 16.

The at least one processor 14 may include a processor unit, a microprocessor, an application-specific integrated circuit, and a field programmable gate array, for example.

The web browser 16 is a software application configured for retrieving, presenting, and traversing information resources on the Internet.

The web browser 16 is embedded with a Virtual Reality (VR) client 18. The VR client 18 is a Virtual Reality Modeling Language (VRML) viewer that displays a virtual environment of the scene on the display screen 20 by playing the real-time images from the IP camera 4. In the embodiment, the VR client 18 may be a VRML software component that is embedded in the web browser 16.

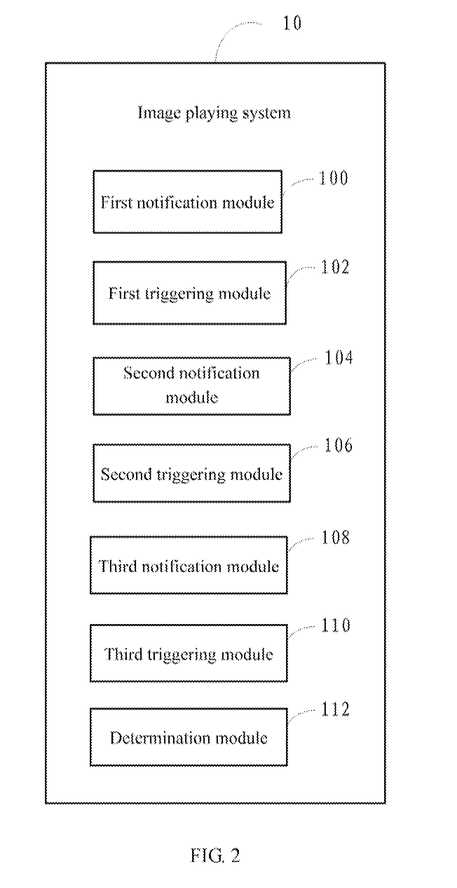

In one embodiment, the image playing system 10 includes a plurality of function modules (see FIG. 2 below), which include computerized codes or instructions that can be stored in the storage device 12 and executed by the at least one processor 14 to provide a method for playing a real-time image in a virtual reality.

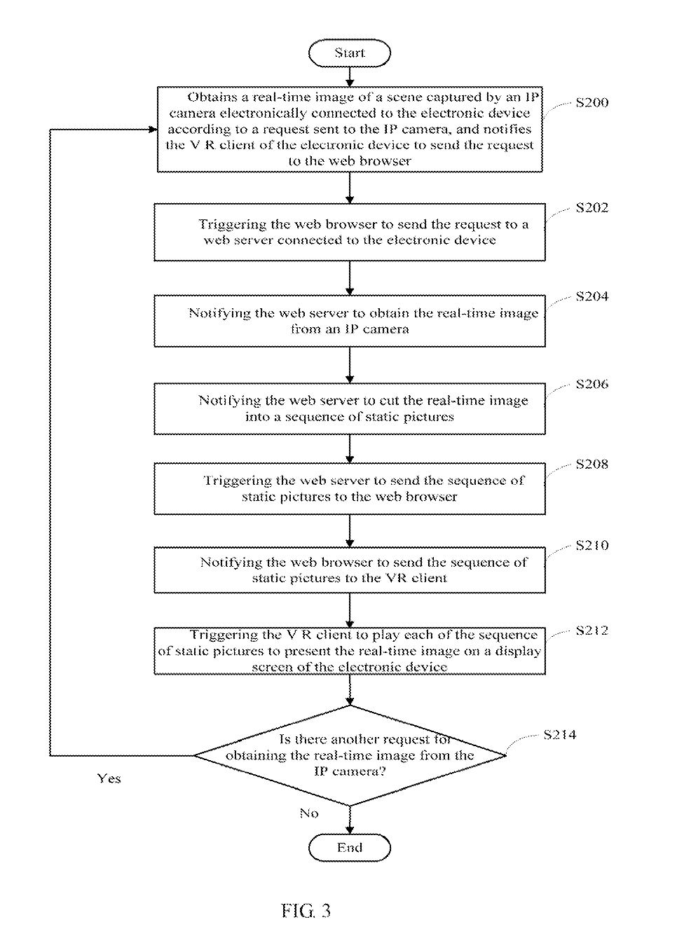

FIG. 2 is a block diagram of one embodiment of the image play system 10 included in the electronic device 1. In one embodiment, the image playing system 10 may include a first notification module 100, a first triggering module 102, a second notification module 104, a second triggering module 106, a third notification module 108, a third triggering module 110 and a determination module 112. The modules may comprise computerized codes in the form of one or more programs that are stored in the storage device 12 and executed by the at least one processor 14 to provide functions for implementing the modules. The functions of the function modules 100-112 are illustrated in FIG. 3 and described below.

FIG. 3 illustrates a flowchart of one embodiment of a method for playing a real-time image in a virtual reality. Depending on the embodiment, additional steps may be added, others removed, and the ordering of the steps may be changed.

In step S200, the first notification module 100 obtains a real-time image of a scene captured from the IP camera 4 according to a request sent to the IP camera, and notifies the VR client 18 of the electronic device 1 to send the request to the web browser 16 of the electronic device 1. The real-time image is obtained by requesting the IP camera 4 to obtain the real-time image through the network 2.

In step S202, the first triggering module 102 triggers the web browser 16 to send the request to the web server 3 through the network 2. In the embodiment, the web browser 16 sends the request to the web server 3 by means of a technique of Asynchronous JavaScript And XML (AJAX). The technique of AJAX is usually used to create an asynchronous web application which can be used to send data, or retrieve data from the web server 3 without interfering with a display of web pages. In the embodiment, by means of the technique of AJAX, the VR client 18 can play the real-time image continuously, and does not slow down a loading speed for displaying the web pages.

In step S204, the second notification module 104 notifies the web server 3 to obtain the real-time image from the IP camera 4. In one embodiment, the format of the real-time image is Motion Joint Photographic Experts Group (MJPEG) format. The real-time image is captured by the IP camera 4, and the IP camera 4 converts the real-time image to the MJPEG format.

In step S206, the second notification module 104 notifies the web server 3 to divide the real-time image into a sequence of static pictures.

In step S208, the second triggering module 106 triggers the web server 3 to send the sequence of static pictures to the web browser 16.

In step S210, the third notification module 108 notifies the web browser 16 to send the sequence of static pictures to the VR client 18.

In step S212, the third triggering module 110 triggers the VR client 18 to play each of the sequence of static pictures to present the real-time image on the display screen 20.

In step S214, the determination module 112 determines whether there is another request for obtaining the real-time image from the IP camera 4. If there is another request for obtaining the real-time image from the IP camera 4, the procedure repeats the step 200 to the step 214. Otherwise, if there is no request for obtaining the real-time image from the IP camera 4, the procedure ends.

As described above, from the step S200 to the step S214, the VR program 18 obtains the real-time image just through a URL provided by the web server 3, and directly plays the real-time image in a virtual reality, so as to avoid opening a media player of the electronic device 1 to play the image.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a web browser;
a Virtual Reality(VR) client;
a display screen;
a storage device;
at least one processor; and
one or more modules that are stored in the storage device and executed by the at least one processor, the one or more modules comprising:
a first notification module that obtains a real-time image of a scene captured by an IP camera electronically connected to the electronic device according to a request sent to the IP camera, and notifies the VR client of the electronic device to send the request to the web browser;
a first triggering module that triggers the web browser to send the request to a web server connected to the electronic device;
a second notification module that notifies the web server to obtain the real-time image from the IP camera;
a second notification module that notifies the web server to divide the real-time image into a sequence of static pictures;
a second triggering module that triggers the web server to send the sequence of static pictures to the web browser;
a third notification module that notifies the web browser to send the sequence of static pictures to the VR client;
a third triggering module that triggers the VR client to play each of the sequence of static pictures to present the real-time image on the display screen.

2. The electronic device according to claim 1, wherein the VR client is a Virtual Reality Modeling Language (VRML) software component that is embedded in the web browser.

3. The electronic device according to claim 1, wherein the IP camera converts a format of the real-time image to a Motion Joint Photographic Experts Group (MJPEG) format.

4. A method for playing real-time images in a virtual reality using an electronic device, the method comprising:
(a) obtaining a real-time image of a scene captured by an IP camera electronically connected to the electronic device according to a request sent to the IP camera, and notifies the VR client of the electronic device to send the request to the web browser;
(b) triggering the web browser to send the request to a web server connected to the electronic device;
(c) notifying the web server to obtain the real-time image from the IP camera;
(d) notifying the web server to cut the real-time image into a sequence of static pictures;
(e) triggering the web server to send the sequence of static pictures to the web browser;
(f) notifying the web browser to send the sequence of static pictures to the VR client;
(g) triggering the VR client to play each of the sequence of static pictures to present the real-time image on a display screen of the electronic device.

5. The method according to claim 4, further comprising:
determining whether there is another request for obtaining the real-time image from the IP camera; and
repeating the step (a) to step (g) if there is another request for obtaining the real-time image from the IP camera.

6. The method according to claim 4, wherein the VR client is a Virtual Reality Modeling Language (VRML) software component that is embedded in the web browser.

7. The method according to claim 4, wherein the IP camera converts a format of the real-time image to a Motion Joint Photographic Experts Group (MJPEG) format.

8. A non-transitory computer-readable storage medium having stored thereon instructions capable of being executed by a processor of an electronic device, causes the processor to perform a method for playing real-images in a virtual reality, the method comprising:
(a) obtains a real-time image of a scene captured by an IP camera electronically connected to the electronic device according to a request sent to the IP camera, and notifies the VR client of the electronic device to send the request to the web browser;
(b) triggering the web browser to send the request to a web server connected to the electronic device;
(c) notifying the web server to obtain the real-time image from the IP camera;
(d) notifying the web server to cut the real-time image into a sequence of static pictures;
(e) triggering the web server to send the sequence of static pictures to the web browser;
(f) notifying the web browser to send the sequence of static pictures to the VR client;
(g) triggering the VR client to play each of the sequence of static pictures to present the real-time image on a display screen of the electronic device.

9. The storage medium according to claim 8, wherein the method further comprises:
determining whether there is another request for obtaining the real-time image from the IP camera; and
repeating the step (a) to step (g) if there is another request for obtaining the real-time image from the IP camera.

10. The storage medium according to claim 8, wherein the VR client is a Virtual Reality Modeling Language (VRML) software component that is embedded in the web browser.

11. The storage medium according to claim 8, wherein the IP camera converts a format of the real-time image to a Motion Joint Photographic Experts Group (MJPEG) format.
